(19) United States
(12) Patent Application Publication
(10) Pub. No.: US 2026/0341249 A1
(43) Pub. Date: Oct. 29, 2026

(54) DYNAMIC, LOCALIZED SCREEN INTENSITY REDUCTION FOR UNDER-DISPLAY AMBIENT LIGHT SENSOR

(71) Applicant: QUALCOMM Incorporated, San Diego, CA (US)

(72) Inventors: Nan ZHANG, Beijing (CN); Long HAN, Shanghai (CN)

(21) Appl. No.: 19/118,249

(22) PCT Filed: Oct. 31, 2022
(86) PCT No.: PCT/CN2022/128651

§ 371 Date: Apr. 3, 2025

(51) Int. Cl. G09G 5/10; G01J 1/42

(52) U.S. Cl. CPC G09G 5/10; G01J 1/4204; G09G 2320/0626; G09G 2320/0686; G09G 2330/021; G09G 2354/00; G09G 2360/144

(57) ABSTRACT

Disclosed are techniques for dynamic, localized screen intensity reduction for an under-display ambient light sensor. In an aspect, an apparatus, such as a cellphone or other mobile device may determine a first ambient light intensity value using an under-display ambient light sensor located under a display screen. The apparatus may determine that the first ambient light intensity value is below a first ambient light intensity threshold. The apparatus may modify an image being displayed within a first region of the display screen, wherein the first region of the display screen comprises less than all pixels in the display screen and comprises at least the pixels of the display screen located above the under-display ambient light sensor.

### BACKGROUND OF THE DISCLOSURE

### 1. Field of the Disclosure Aspects of the disclosure relate generally to addressing some of the challenges faced when detecting ambient light using under-display ambient light sensors.

### 2. Description of the Related Art

For cellphones and other battery-powered mobile devices, the brightness of the display can strongly affect its power consumption, i.e., a brightly-lit display consumes much more power than a dimly-light display. For this reason, it is desirable to reduce the display brightness to the minimum level needed for the user to comfortably see the screen. In a dark room, for example, the display can be quite dim and still be usable, but in bright daylight, the display may need to be quite bright. To avoid the user having to constantly adjust the brightness of the display in changing light conditions, cellphones typically include an ambient light sensor, from which the device can determine how bright or dark the environment is, and from that can adjust the display brightness up and down automatically.

Ambient light sensors also provide valuable information to the cellphone camera circuity, e.g., to determine exposure time, for color correction, for gamma adjustment, and so on. for need to adjust the intensity (brightness) of the display. In some mobile devices, the ambient light sensor is outside of the display, which limits how much of the user-facing surface the display can occupy. Other mobile devices use what is called an under-display ambient light sensor, where the term “under” refers to the ambient light sensor's location below an upward-facing display surface; from the perspective of a user facing the display, the ambient light sensor is behind the display screen.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method for dynamic includes determining a first ambient light intensity value using an under-display ambient light sensor located under a display screen; determining that the first ambient light intensity value is below a first ambient light intensity threshold; and modifying an image being displayed within a first region of the display screen, wherein the first region of the display screen comprises less than all pixels in the display screen and comprises at least the pixels of the display screen located above the under-display ambient light sensor.

In an aspect, an apparatus includes a memory; at least one transceiver; and at least one processor communicatively coupled to the memory and the at least one transceiver, the at least one processor configured to: determine a first ambient light intensity value using an under-display ambient light sensor located under a display screen; determine that the first ambient light intensity value is below a first ambient light intensity threshold; and modify an image being displayed within a first region of the display screen, wherein the first region of the display screen comprises less than all pixels in the display screen and comprises at least the pixels of the display screen located above the under-display ambient light sensor.

In an aspect, an apparatus includes means for determining a first ambient light intensity value using an under-display ambient light sensor located under a display screen; means for determining that the first ambient light intensity value is below a first ambient light intensity threshold; and means for modifying an image being displayed within a first region of the display screen, wherein the first region of the display screen comprises less than all pixels in the display screen and comprises at least the pixels of the display screen located above the under-display ambient light sensor.

In an aspect, a non-transitory computer-readable medium storing computer-executable instructions that, when executed by an apparatus, cause the apparatus to: determine a first ambient light intensity value using an under-display ambient light sensor located under a display screen; determine that the first ambient light intensity value is below a first ambient light intensity threshold; and modify an image being displayed within a first region of the display screen, wherein the first region of the display screen comprises less than all pixels in the display screen and comprises at least the pixels of the display screen located above the under-display ambient light sensor.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIGS. 1A-1C illustrate conventional implementations of ambient light sensors.

FIGS. 2A-2F illustrate dynamic, localized screen intensity reduction for an under-display ambient light sensor, according to aspects of the disclosure.

FIG. 3 is a flowchart illustrating a process 300 for dynamic, localized screen intensity reduction for an under-display ambient light sensor, according to aspects of the disclosure.

FIG. 4 is a flowchart illustrating a process 400 for dynamic, localized screen intensity reduction for an under-display ambient light sensor, according to aspects of the disclosure.

FIG. 5 is a flowchart of an example process 500 associated with dynamic, localized screen intensity reduction for an under-display ambient light sensor, according to aspects of the disclosure.

### DETAILED DESCRIPTION

Disclosed are techniques for dynamic, localized screen intensity reduction for an under-display ambient light sensor. In an aspect, an apparatus, such as a cellphone or other mobile device may determine a first ambient light intensity value using an under-display ambient light sensor located under a display screen. The apparatus may determine that the first ambient light intensity value is below a first ambient light intensity threshold. The apparatus may modify an image being displayed within a first region of the display screen, wherein the first region of the display screen comprises less than all pixels in the display screen and comprises at least the pixels of the display screen located above the under-display ambient light sensor.

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

For cellphones and other battery-powered mobile devices, the brightness of the display can strongly affect its power consumption, i.e., a brightly-lit display consumes much more power than a dimly-light display. For this reason, it is desirable to reduce the display brightness to the minimum level needed for the user to comfortably see the screen. In a dark room, for example, the display can be quite dim and still be usable, but in bright daylight, the display may need to be quite bright. To avoid the user having to constantly adjust the brightness of the display in changing light conditions, cellphones typically include an ambient light sensor, from which the device can determine how bright or dark the environment is, and from that can adjust the display brightness up and down automatically. Ambient light sensors also provide valuable information to the cellphone camera circuity, e.g., to determine exposure time, for color correction, for gamma adjustment, and so on. for need to adjust the intensity (brightness) of the display.

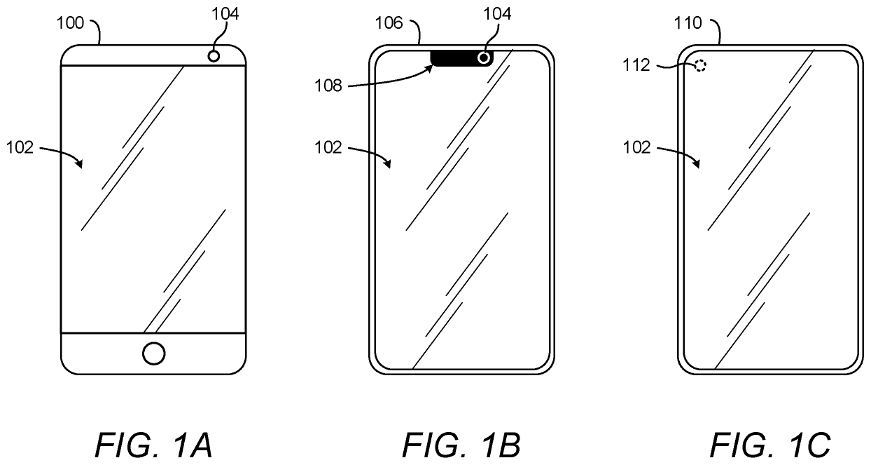

FIG. 1A, FIG. 1B, and FIG. 1C illustrate conventional implementations of ambient light sensors. FIG. 1A illustrates a mobile device 100 having a display screen 102 and an ambient light sensor 104 that is outside of the display area. This limits how much of the user-facing surface the display screen 102 can occupy. In this type of mobile device 100, the display screen 102 does not cover the entire user-facing surface but is instead bound by at least one non-display border that contains ambient light sensor, e.g., the horizontal strip above the display screen 102. FIG. 1B illustrates a mobile device 106 that also has an ambient light sensor outside of the display screen 102. In this design, the display 102 has a notch 108 that accommodates the ambient light sensor 104. It is noted that this notch 108 is a non-display area. FIG. 1C illustrates a mobile device 110 that uses what is called an under-display ambient light sensor 112, where the term “under” refers to the ambient light sensor's location below an upward-facing display surface; from the perspective of a user facing the display, the under-display ambient light sensor 112 is behind the display screen 102. The use of an under-display ambient light sensor 112 allows the display screen 102 to cover the portion of the user-facing surface that would otherwise be non-display area.

One problem with under-display ambient light sensors is that they can also detect some light coming from the display itself. When ambient light levels are high, the additional light coming from the display is negligible compared to the ambient light, and thus does not greatly affect the ambient light level reported by the ambient light sensor. When ambient light levels are low, however, the light coming from the display can have an unduly large influence on the ambient light level reported by the ambient light sensor.

For this reason, under-display ambient light sensors require complex run-time calibration to compensate for the light emitted by the display pixels. This typically includes run-time capture and analysis of the pixel contents of run-time display frames, and run-time calibration of the ambient light sensor to compensate for the effects of the display pixels. Even with this run-time calibration, however, the display pixels still have huge effects on the ambient light sensor in different scenarios. For example, run-time calibration of ambient light color sensing or color-temperature sensing is very challenging compared with a simple luminance sensor, and calibrating a color sensor in a very dark environment is extremely difficult, both due to the light from the display itself.

Accordingly, techniques for dynamic, localized screen intensity reduction for under-display ambient light sensor are herein presented. In order to reduce the effect that the display pixels may have on the under-display ambient light sensor in low ambient light conditions, the ambient light levels are continually monitored, and when ambient light levels drop below a particular threshold value, the region of the display over the under-display ambient light sensor is modified, i.e., the pixels in that region are reduced in intensity, are set to display black, or are turned off entirely. If ambient light levels go above that (or another) threshold value, the pixels in the region over the under-display ambient light sensor are fully or partially restored to their default values, i.e., the intensities of those display pixels are restored to their unmodified values.

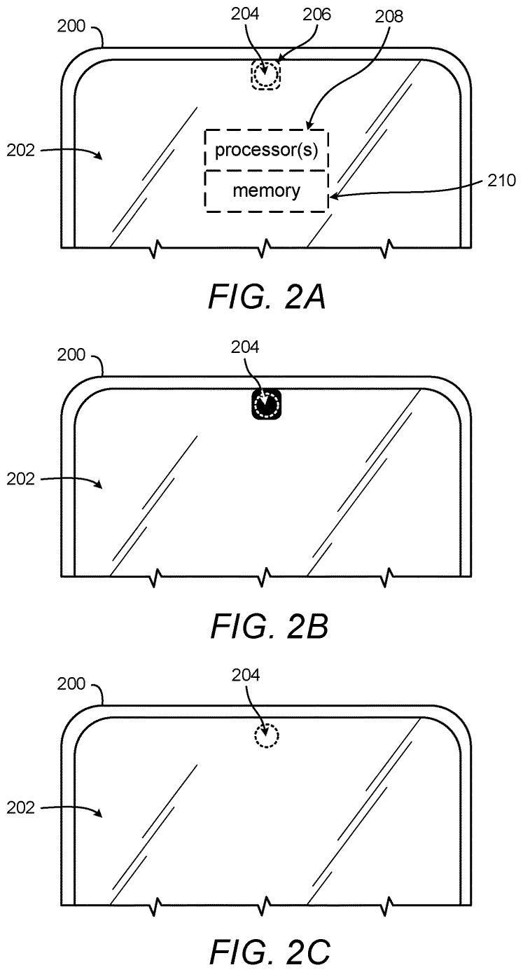

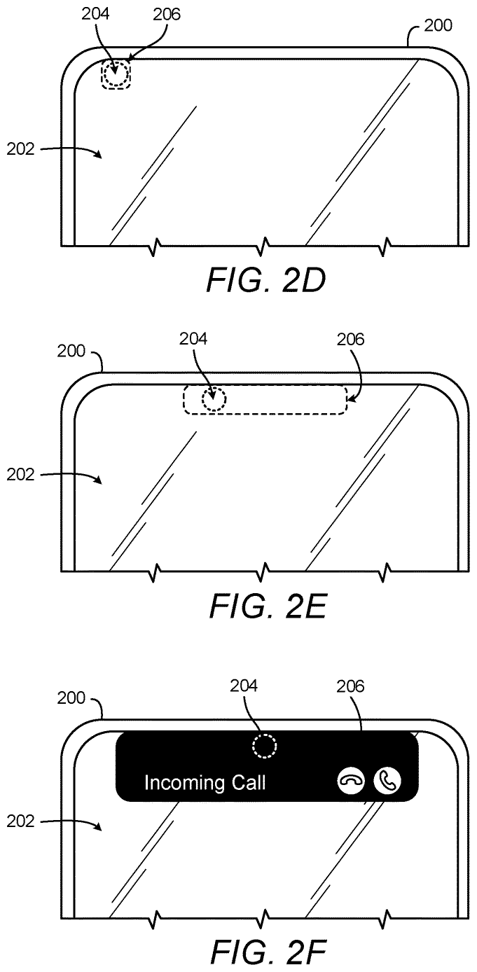

FIG. 2A through FIG. 2F illustrate dynamic, localized screen intensity reduction for an under-display ambient light sensor, according to aspects of the disclosure. In each of FIGS. 2A-2F, a mobile device 200 includes a display 202 and an under-display ambient light sensor 204, which may be also referred to herein as “the ambient light sensor 204,” “the light sensor 240,” or simply “the sensor 204.” The display 202 includes a region 206 that is “above” the under-display ambient light sensor 204. The mobile device 200 includes one or more processor(s) 208 and a memory 210 coupled to the processor(s) 208. At least a portion of the memory 210 may be a display memory that is coupled to the display 202 and that may operate as a display buffer, e.g., containing the image values for each pixel of the display 202. For clarity, the processor(s) 208 and memory 210 are shown within FIG. 2A only.

FIG. 2A illustrates an implementation in which the region 206 is a rounded rectangle that is slightly bigger than the sensor 204, which is centered within the region 206. The exact shape of the region 206 may depend upon the exact shape of the sensor 204, but generally includes at least the area of the display 202 having pixels that, if illuminated, may generate light that may be picked up by the sensor 204. In some aspects, this may include just the pixels directly above the sensor 204. In some aspects, this may include not only those pixels previously mentioned but also additional pixels out to some predetermined distance away from the outer perimeter of the sensor 204. In some aspects, the predetermined distance away from the outer perimeter of the sensor 204 is defined such that the region 206 contains all of the pixels that are likely to produce light that might be picked up by the sensor 204. In some aspects, the predetermined distance may be dynamically calculated based on the current brightness of the pixels near the outer perimeter of the sensor 204, the current ambient light value, and other factors.

FIG. 2B illustrates the scenario in which the brightness of the ambient light detected by the sensor 204 is below an ambient light threshold T. In this scenario, the region 206 is darkened to reduce the amount of light from the pixels of the display 202 within the region 206 that might be detected by the sensor 204. In some aspects, the pixels within the region 206 are turned off entirely. In some aspects, the pixels within the region 206 are set to display black. In some aspects, the pixels within the region 206 are dimmed relative to the brightness of the rest of the display 202, e.g., by some percentage of what their brightness values would have been had they not been dimmed.

FIG. 2C illustrates the scenario in which the brightness of the ambient light detected by the sensor 204 is not below the ambient light threshold T (or above a different ambient light threshold T′ that may be different from T, e.g., to provide hysteresis). In this scenario, the region 206 is not darkened relative to the rest of the display 202, e.g., by remaining unmodified or by being restored to its unmodified state if it was previously modified as shown in FIG. 2B.

In one implementation, for example, the display 202 may have a global brightness value B that is the baseline brightness value for all pixels, with the individual pixels' values being a combination of the baseline brightness value and the brightness value for the individual pixel according to the image being displayed. In this approach, the value of B may be set based on the brightness of the ambient light detected by the sensor 204. In the example shown in FIG. 2B, the baseline value of the region 206, referred to herein as R, may be set to zero or set to some fraction of the baseline value B, e.g., 50% of B, 10% of B, etc. In some aspects, the amount of reduction may be inversely proportional to the ambient light measurement value, e.g., the lower the ambient light value the greater the reduction in brightness within the region 206. In the example shown in FIG. 2C, the value of R may be set to equal the value of B, or the region 206 may be otherwise set or restored to the brightness that it would have been without the modification shown in FIG. 2B.

In some aspects, whenever the value of R (or the brightness of the region 206) is modified, whether to reduce it relative to the rest of the display 202 or to restore it to a value that it would have been prior to modification, another ambient light measurement may be taken and the process may repeat.

For example, if the region 206 is not dimmed, as shown in FIG. 2C, and the ambient light value is below a threshold value, in some aspects, the brightness of the display 202 is set based on that ambient light value, then the brightness of the region 206 is reduced as shown in FIG. 2B, another ambient light value measurement is taken, and the new ambient light value is used to adjust the brightness of the display 202 except for the region 206. Alternatively, in some aspects, when the ambient light value is below a threshold value, the brightness of the display 202 is not set at that time; instead, the brightness of the display 202 is not adjusted until after the brightness of the region 206 is reduced, another ambient light value measurement is taken, and the new ambient light value is used to adjust the brightness of the display 202 except for the region 206.

Likewise, if the region 206 is dimmed, as shown in FIG. 2B, and the ambient light value is not below the threshold value, the brightness of the region 206 may be restored to its unmodified state, as shown in FIG. 2C. In some aspects, the previously measured value for ambient light is presumed to still be correct and another ambient light measurement need not be taken. Alternatively, in some aspects, another ambient light measurement is taken anyway and the brightness of the entire display 202 including the region 206 is updated based on the newest ambient light measurement value.

In some aspects, the brightness of the entire display 202 including the region 206 is continually adjusted based on the latest ambient light measurement value, and the brightness of the region 206 is modified by a separate process that dims the brightness of the region 206 when the ambient light measurement is below a threshold value and restores the brightness of the region 206 to its unmodified state when the ambient light measurement is not below the threshold value.

In some aspects, two ambient light threshold values are used to provide some hysteresis to the process of modifying the brightness of the region 206. For example, region 206 may be dimmed if the ambient light value is below a first threshold T1 and restore if the ambient light value is above a second threshold T2, where T1<T2. In some aspects, the ambient light threshold(s) may be statically provisioned or preconfigured. In some aspects, the ambient light threshold(s) may be run-time adjustable.

FIG. 2D illustrates an embodiment in which the under-display ambient light sensor 204 and its corresponding region 206 is located in the corner of the display 202 rather than centered at the top of the display 202. FIG. 2D illustrates the point that the sensor 204 can be located anywhere within the area of the display 202.

FIG. 2E illustrates an embodiment in which the region 206 is larger than the minimum area needed to reduce the display light that may be picked up by the sensor 204. This may be done for aesthetic reasons, e.g., to display a notch that is centered left-to-right rather than an off-center notch, or for practical reasons, e.g., to allow for additional information to be displayed in the blacked out region, such as shown in FIG. 2F.

FIG. 2F illustrates an embodiment in which the region 206 is integrated with, or used for, a region having other purposes. In the example illustrated in FIG. 2F, the region 206 is also used to provide notification of an incoming call, but this example is illustrative and not limiting. FIG. 2F illustrates the point that the size of the region 206 may be dynamic, and may be resized depending on need.

In some aspects, the size, shape, or other characteristics of the dimmed region 206 may be controlled by the OS, and may have characteristics that are controlled by an application's user interface (UI) theme. In some aspects, the change of region 206 from modified (e.g., dimmed or blacked out) to unmodified may be according to a transition effect, e.g., fading in and fading out, a drop-down and its reverse, a wipe transition, and so on. In some aspects, the OS or application that is controlling what is being displayed may adjust the contents of the display to accommodate the region 206 when it is dimmed, e.g., by relocating visual features out of the region 206 to some other location within the display 202. It is noted that the techniques disclosed herein may be applied also to multiple under-display ambient light sensors 204.

The techniques described include, but are not limited to, the following advantages. The accuracy of the under-display ambient light sensor 204 will be greatly improved when there is very low or no ambient light. As a result, the brightness of the display 202 will be more accurately set for the ambient light conditions; photos and videos taken by an on-device camera will have a more accurate ambient light reading, which will result in higher picture quality. In contrast to conventional approaches, in which the ambient light sensor must be continually recalibrated to compensate for the current pixel intensities above ambient light sensor, the techniques described herein obviate the need to continually perform such calibrations when the region 206 is blacked out, for example. The implementation of this technique may be relatively simple, e.g., by setting pixel values within the region 206 to zero, which may be performed by a simple mask operation.

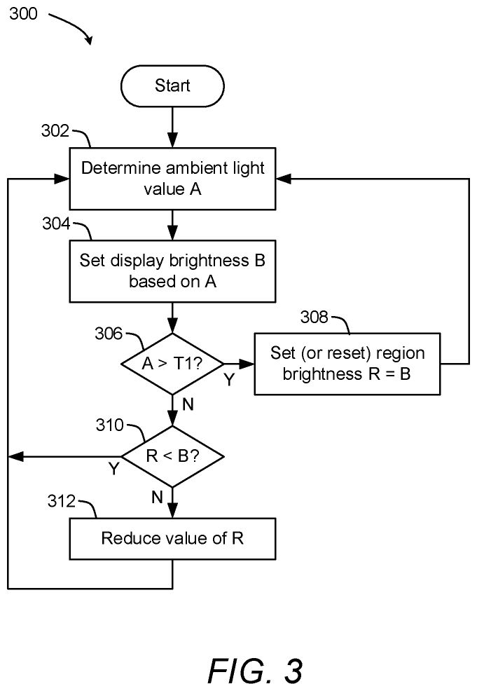

FIG. 3 is a flowchart illustrating a process 300 for dynamic, localized screen intensity reduction for an under-display ambient light sensor, according to aspects of the disclosure. The steps of this process 300 may be performed, for example, by a cellphone, other mobile device 200, or any type of device having a display 202 and an under-display ambient light sensor 204, and having a portion of the display 202 defined as a region 206. For illustrative purposes only and without limitation, the ambient light value measured is referred to as “A”, the baseline brightness of the display except for the region is referred to as “B”, and the baseline brightness of the region is referred to as “R”.

As shown in FIG. 3, process 300 may include, at block 302, determining an ambient light value A. In some aspects, this value may be determined by one or more under-display ambient light sensors 204.

As shown in FIG. 3, process 300 may further include, at block 304, setting the display brightness B based on the value of A. In some aspects, this calculation may be performed by one or more processor(s) operating on the contents of a memory, such as a display buffer. In some aspects, the value of A is used to define a baseline brightness B for all pixels of the display, where each pixel's individual brightness is further modified by the image being displayed. In some aspects, the value of A is used to individually calculate the brightness of each pixel in the image being displayed. For the illustration only, process 300 presumes the use of a baseline brightness value B, but other implementations that do not use a baseline value B are contemplated by the present disclosure.

As shown in FIG. 3, process 300 may further include, at block 306, determining whether A is greater than a first ambient light value threshold T1. In some aspects, this calculation may be performed by a processor operating on the contents of a display memory, or by a dedicated circuit associated with the ambient light sensor.

As shown in FIG. 3, if A is greater than T1, process 300 may include, at block 308, setting the brightness of the region based of the baseline value B. That is, if the region had been previously modified (e.g., blacked out or dimmed) so that the brightness of the region is less than the brightness of the remainder of the display (e.g., R<B), block 308 removes this prior modification so that the brightness of the region R is in keeping with the brightness of the rest of the display B (e.g., R=B).

As shown in FIG. 3, if A is not greater that T1, then the region of the display that is over the under-display ambient light sensor should be modified (e.g., blacked out or dimmed); therefore process 300 may include, at block 310, determining whether the region has already been modified (e.g., R<B). In the example shown in FIG. 3, if the region has already been modified, then no further modification is needed and the process repeats starting from block 302. However, if the region is currently unmodified, then, at block 312, the brightness of the region is reduced, e.g., dimmed or fully blacked out, and the process repeats starting from block 302.

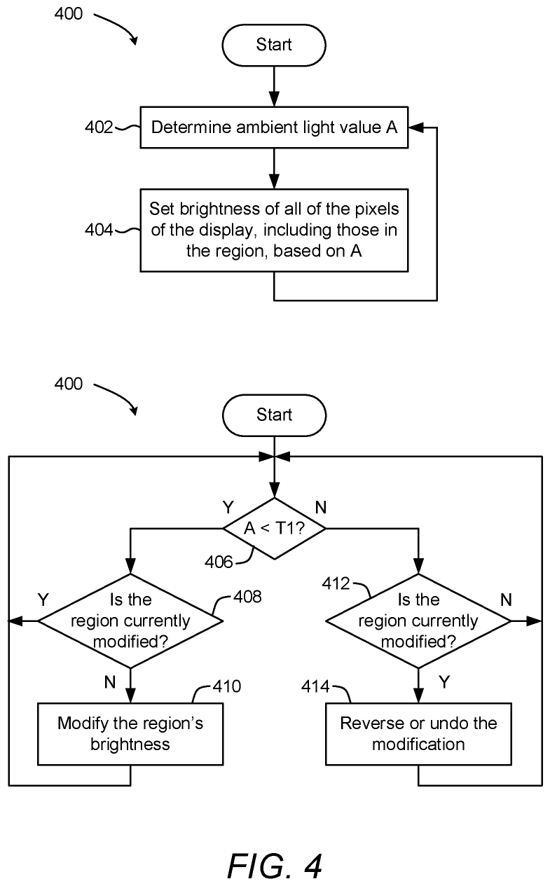

FIG. 4 is a flowchart illustrating a process 400 for dynamic, localized screen intensity reduction for an under-display ambient light sensor, according to aspects of the disclosure. The steps of this process 400 may be performed, for example, by a cellphone, other mobile device 200, or any type of device having a display 202 and an under-display ambient light sensor 204, and having a portion of the display 202 defined as a region 206. For illustrative purposes only and without limitation, the ambient light value measured is referred to as “A”.

As shown in FIG. 4, process 400 includes two independent decision loops. In the first loop, the ambient light value A is continually monitored (block 402) and the brightness of all of the pixels in the display, including the region, are set based on the value of A (block 404). In the second loop, the value of A is continually being checked to see if it has dropped below a threshold value T1 (block 406). If A is less than T1, then the region must be modified (e.g., the pixels should be blanked or dimmed). Thus, at block 408, the process determines whether the region has already been modified: if so, the process repeats starting from block 406; if not, the region is modified (block 410) before looping from block 406. If, at block 406, A is not less than T1, then the region should be restored to its unmodified valued. Thus, at block 412, the process determines whether the region is currently modified: if not, the process loops from block 406; if so, the modification is reversed or undone (block 414) before looping from block 406.

It will be understood by one of ordinary skill in the art that the specific process steps shown in FIG. 3 and FIG. 4 represent alternative implementations that achieve the same purpose—namely, to modify a region of a display that is above an under-display ambient light sensor so that the under-display ambient light sensor reading is not affected by the light that would otherwise be emitted from pixels of the display within that region and contaminate that ambient light reading. Accordingly, the methods shown in FIG. 3 and FIG. 4 are illustrative and not limiting. Other implementations that similarly modify a portion of the display above an under-display ambient light sensor to avoid or reduce contamination of an ambient light reading by the light that would otherwise be emitted by the display pixels are contemplated by the present disclosure.

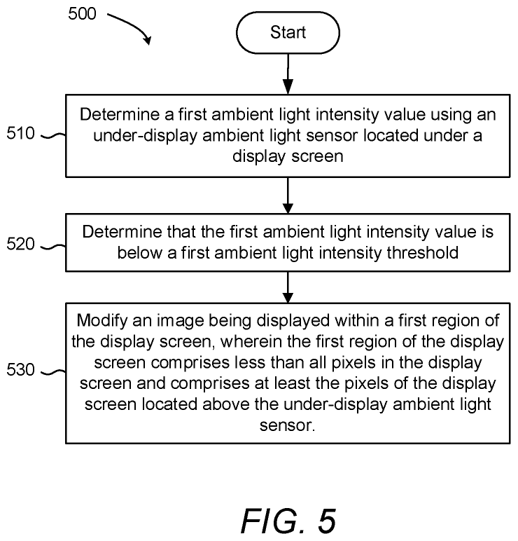

FIG. 5 is a flowchart of an example process 500 associated with dynamic, localized screen intensity reduction for an under-display ambient light sensor, according to aspects of the disclosure. In some implementations, one or more process blocks of FIG. 5 may be performed by a device (e.g., mobile device 200). In some implementations, one or more process blocks of FIG. 5 may be performed by another device or a group of devices separate from or including the device. Additionally, or alternatively, one or more process blocks of FIG. 5 may be performed by one or more components of an apparatus, such as one or more processor(s) 208 or memory 210 of mobile device 200, any or all of which may be means for performing the operations of process 500.

As shown in FIG. 5, process 500 may include determining a first ambient light intensity value using an under-display ambient light sensor located under a display screen (block 510). Means for performing the operation of block 510 may include the processor(s) 208, memory 210, or sensor(s) 204 of mobile device 200. For example, the mobile device 200 may determine a first ambient light intensity value using the under-display ambient light sensor located 204.

As further shown in FIG. 5, process 500 may include determining that the first ambient light intensity value is below a first ambient light intensity threshold (block 520). Means for performing the operation of block 510 may include the processor(s) 208, memory 210, or sensor(s) 204 of mobile device 200. For example, the mobile device 200 may determine that the first ambient light intensity value is below a first ambient light intensity threshold, using the processor(s) 208.

As further shown in FIG. 5, process 500 may include modifying an image being displayed within a first region of the display screen, wherein the first region of the display screen comprises less than all pixels in the display screen and comprises at least the pixels of the display screen located above the under-display ambient light sensor (block 530). Means for performing the operation of block 510 may include the processor(s) 208, memory 210, or sensor(s) 204 of mobile device 200. For example, the processor(s) 208 of the mobile device 200 may modify an image being displayed within a first region of the display screen by modifying the contents of a display buffer located in the memory 210.

In some aspects, modifying the image being displayed within the first region of the display screen based on the first ambient light intensity value comprises reducing a brightness of the pixels in the first region, changing a color of the pixels in the first region to black, or turning off the pixels in the first region.

In some aspects, reducing the brightness of the pixels in the first region comprises setting the brightness of the pixels to a zero value, or reducing the brightness of the pixels by a percentage.

In some aspects, process 500 further includes determining a second ambient light intensity value using the under-display ambient light sensor located under the display screen, and setting a brightness of the image being displayed based on the second ambient light intensity value, using the second ambient light intensity value by image capture hardware and/or software, or a combination thereof.

In some aspects, process 500 further includes determining a third ambient light intensity value using the under-display ambient light sensor located under the display screen, determining that the third ambient light intensity value is above a second ambient light intensity threshold, and reversing or cancelling modifications made to the image being displayed within the first region of the display screen.

In some aspects, reversing or cancelling the modifications made to the image being displayed within the first region of the display screen comprises restoring a brightness of the pixels in the first region to their unmodified state, changing a color of the pixels in the first region from black to the unmodified color, or turning on the pixels in the first region.

In some aspects, process 500 further includes determining a fourth ambient light intensity value using the under-display ambient light sensor located under the display screen, and setting a brightness of the image being displayed based on the fourth ambient light intensity value, using the fourth ambient light intensity value by image capture hardware and/or software, or a combination thereof.

In some aspects, the value of the first ambient light intensity threshold and the value of the second ambient light intensity threshold are the same value.

In some aspects, the value of the first ambient light intensity threshold is less than the value of the second ambient light intensity threshold.

In some aspects, the first region of the display screen further comprises pixels within a predetermined distance from an outer boundary of the under-display ambient light sensor.

In some aspects, sizing, shape, or area of the first region of the display screen is dynamically adjusted by an operating system or application.

In some aspects, modifying the image being displayed within a first region of the display screen further comprises displaying additional information with the first region.

In some aspects, modifying the image being displayed within a first region of the display screen comprises performing a transition effect from an unmodified state to a modified state or from the modified state to the unmodified state.

In some aspects, process 500 further includes adjusting a user interface element in response to modifying the image being displayed within a first region of the display screen.

Process 500 may include additional implementations, such as any single implementation or any combination of implementations described below and/or in connection with one or more other processes described elsewhere herein. Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method for dynamic, localized screen intensity reduction for an under-display ambient light sensor, the method comprising: determining a first ambient light intensity value using an under-display ambient light sensor located under a display screen; determining that the first ambient light intensity value is below a first ambient light intensity threshold; and modifying an image being displayed within a first region of the display screen, wherein the first region of the display screen comprises less than all pixels in the display screen and comprises at least the pixels of the display screen located above the under-display ambient light sensor.

Clause 2. The method of clause 1, wherein modifying the image being displayed within the first region of the display screen based on the first ambient light intensity value comprises reducing a brightness of the pixels in the first region, changing a color of the pixels in the first region to black, or turning off the pixels in the first region.

Clause 3. The method of clause 2, wherein reducing the brightness of the pixels in the first region comprises setting the brightness of the pixels to a zero value, or reducing the brightness of the pixels by a percentage.

Clause 4. The method of any of clauses 1 to 3, further comprising: determining a second ambient light intensity value using the under-display ambient light sensor located under the display screen; and setting a brightness of the image being displayed based on the second ambient light intensity value, using the second ambient light intensity value by image capture hardware and/or software, or a combination thereof.

Clause 5. The method of any of clauses 1 to 4, further comprising: determining a third ambient light intensity value using the under-display ambient light sensor located under the display screen; determining that the third ambient light intensity value is above a second ambient light intensity threshold; and reversing or cancelling modifications made to the image being displayed within the first region of the display screen.

Clause 6. The method of clause 5, wherein reversing or cancelling the modifications made to the image being displayed within the first region of the display screen comprises restoring a brightness of the pixels in the first region to their unmodified state, changing a color of the pixels in the first region from black to the unmodified color, or turning on the pixels in the first region.

Clause 7. The method of any of clauses 5 to 6, further comprising: determining a fourth ambient light intensity value using the under-display ambient light sensor located under the display screen; and setting a brightness of the image being displayed based on the fourth ambient light intensity value, using the fourth ambient light intensity value by image capture hardware and/or software, or a combination thereof.

Clause 8. The method of any of clauses 5 to 7, wherein a value of the first ambient light intensity threshold and a value of the second ambient light intensity threshold are the same value.

Clause 9. The method of any of clauses 5 to 8 wherein a value of the first ambient light intensity threshold is less than a value of the second ambient light intensity threshold.

Clause 10. The method of any of clauses 1 to 9, wherein the first region of the display screen further comprises pixels within a predetermined distance from an outer boundary of the under-display ambient light sensor.

Clause 11. The method of any of clauses 1 to 10, wherein size, shape, or area of the first region of the display screen is dynamically adjusted by an operating system or application.

Clause 12. The method of any of clauses 1 to 11, wherein modifying the image being displayed within a first region of the display screen further comprises displaying additional information with the first region.

Clause 13. The method of any of clauses 1 to 12, wherein modifying the image being displayed within a first region of the display screen comprises performing a transition effect from an unmodified state to a modified state or from the modified state to the unmodified state.

Clause 14. The method of any of clauses 1 to 13, further comprising adjusting a user interface element in response to modifying the image being displayed within a first region of the display screen.

Clause 15. An apparatus, comprising: a memory; at least one transceiver; and at least one processor communicatively coupled to the memory and the at least one transceiver, the at least one processor configured to: determine a first ambient light intensity value using an under-display ambient light sensor located under a display screen; determine that the first ambient light intensity value is below a first ambient light intensity threshold; and modify an image being displayed within a first region of the display screen, wherein the first region of the display screen comprises less than all pixels in the display screen and comprises at least the pixels of the display screen located above the under-display ambient light sensor.

Clause 16. The apparatus of clause 15, wherein, to modify the image being displayed within the first region of the display screen based on the first ambient light intensity value, the at least one processor is configured to reduce a brightness of the pixels in the first region, changing a color of the pixels in the first region to black, or turning off the pixels in the first region.

Clause 17. The apparatus of clause 16, wherein, to reduce the brightness of the pixels in the first region, the at least one processor is configured to set the brightness of the pixels to a zero value, or reducing the brightness of the pixels by a percentage.

Clause 18. The apparatus of any of clauses 15 to 17, wherein the at least one processor is further configured to: determine a second ambient light intensity value using the under-display ambient light sensor located under the display screen; and set a brightness of the image being displayed based on the second ambient light intensity value, using the second ambient light intensity value by image capture hardware and/or software, or a combination thereof.

Clause 19. The apparatus of any of clauses 15 to 18, wherein the at least one processor is further configured to: determine a third ambient light intensity value using the under-display ambient light sensor located under the display screen; determine that the third ambient light intensity value is above a second ambient light intensity threshold; and reverse or cancelling modifications made to the image being displayed within the first region of the display screen.

Clause 20. The apparatus of clause 19, wherein, to reverse or cancelling the modifications made to the image being displayed within the first region of the display screen, the at least one processor is configured to restore a brightness of the pixels in the first region to their unmodified state, changing a color of the pixels in the first region from black to the unmodified color, or turning on the pixels in the first region.

Clause 21. The apparatus of any of clauses 19 to 20, wherein the at least one processor is further configured to: determine a fourth ambient light intensity value using the under-display ambient light sensor located under the display screen; and set a brightness of the image being displayed based on the fourth ambient light intensity value, using the fourth ambient light intensity value by image capture hardware and/or software, or a combination thereof.

Clause 22. The apparatus of any of clauses 19 to 21, wherein a value of the first ambient light intensity threshold and a value of the second ambient light intensity threshold are the same value.

Clause 23. The apparatus of any of clauses 19 to 22, The method of any of clauses 19 to 22 wherein a value of the first ambient light intensity threshold is less than a value of the second ambient light intensity threshold.

Clause 24. The apparatus of any of clauses 15 to 23, wherein the first region of the display screen further comprises pixels within a predetermined distance from an outer boundary of the under-display ambient light sensor.

Clause 25. The apparatus of any of clauses 15 to 24, wherein size, shape, or area of the first region of the display screen is dynamically adjusted by an operating system or application.

Clause 26. The apparatus of any of clauses 15 to 25, wherein, to modify the image being displayed within a first region of the display screen, the at least one processor is configured to display additional information with the first region.

Clause 27. The apparatus of any of clauses 15 to 26, wherein, to modify the image being displayed within a first region of the display screen, the at least one processor is configured to perform a transition effect from an unmodified state to a modified state or from the modified state to the unmodified state.

Clause 28. The apparatus of any of clauses 15 to 27, wherein the at least one processor is further configured to adjust a user interface element in response to modifying the image being displayed within a first region of the display screen.

Clause 29. An apparatus, comprising: means for determining a first ambient light intensity value using an under-display ambient light sensor located under a display screen; means for determining that the first ambient light intensity value is below a first ambient light intensity threshold; and means for modifying an image being displayed within a first region of the display screen, wherein the first region of the display screen comprises less than all pixels in the display screen and comprises at least the pixels of the display screen located above the under-display ambient light sensor.

Clause 30. A non-transitory computer-readable medium storing computer-executable instructions that, when executed by an apparatus, cause the apparatus to: determine a first ambient light intensity value using an under-display ambient light sensor located under a display screen; determine that the first ambient light intensity value is below a first ambient light intensity threshold; and modify an image being displayed within a first region of the display screen, wherein the first region of the display screen comprises less than all pixels in the display screen and comprises at least the pixels of the display screen located above the under-display ambient light sensor.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method for dynamic, localized screen intensity reduction for an under-display ambient light sensor, the method comprising:
determining a first ambient light intensity value using an under-display ambient light sensor located under a display screen;
determining that the first ambient light intensity value is below a first ambient light intensity threshold; and
modifying an image being displayed within a first region of the display screen, wherein the first region of the display screen comprises less than all pixels in the display screen and comprises at least the pixels of the display screen located above the under-display ambient light sensor.

2. The method of claim 1, wherein modifying the image being displayed within the first region of the display screen based on the first ambient light intensity value comprises reducing a brightness of the pixels in the first region, changing a color of the pixels in the first region to black, or turning off the pixels in the first region.

3. The method of claim 2, wherein reducing the brightness of the pixels in the first region comprises setting the brightness of the pixels to a zero value, or reducing the brightness of the pixels by a percentage.

4. The method of claim 1, further comprising:
determining a second ambient light intensity value using the under-display ambient light sensor located under the display screen; and
setting a brightness of the image being displayed based on the second ambient light intensity value, using the second ambient light intensity value by image capture hardware and/or software, or a combination thereof.

5. The method of claim 1, further comprising:
determining a third ambient light intensity value using the under-display ambient light sensor located under the display screen;
determining that the third ambient light intensity value is above a second ambient light intensity threshold; and
reversing or cancelling modifications made to the image being displayed within the first region of the display screen.

6. (canceled)

7. (canceled)

8. (canceled)

9. (canceled)

10. The method of claim 1, wherein the first region of the display screen further comprises pixels within a predetermined distance from an outer boundary of the under-display ambient light sensor.

11. The method of claim 1, wherein size, shape, or area of the first region of the display screen is dynamically adjusted by an operating system or application.

12. The method of claim 1, wherein modifying the image being displayed within a first region of the display screen further comprises displaying additional information with the first region.

13. The method of claim 1, wherein modifying the image being displayed within a first region of the display screen comprises performing a transition effect from an unmodified state to a modified state or from the modified state to the unmodified state.

14. The method of claim 1, further comprising adjusting a user interface element in response to modifying the image being displayed within a first region of the display screen.

15. An apparatus, comprising:
a display screen;
an under-display ambient light sensor;
a memory; and
at least one processor communicatively coupled to the memory, the display screen, and the under-display ambient light sensor, the at least one processor configured to:
determine a first ambient light intensity value using the under-display ambient light sensor;
determine that the first ambient light intensity value is below a first ambient light intensity threshold; and
modify an image being displayed within a first region of the display screen, wherein the first region of the display screen comprises less than all pixels in the display screen and comprises at least the pixels of the display screen located above the under-display ambient light sensor.

16. The apparatus of claim 15, wherein, to modify the image being displayed within the first region of the display screen based on the first ambient light intensity value, the at least one processor is configured to reduce a brightness of the pixels in the first region, changing a color of the pixels in the first region to black, or turning off the pixels in the first region.

17. The apparatus of claim 16, wherein, to reduce the brightness of the pixels in the first region, the at least one processor is configured to set the brightness of the pixels to a zero value, or reducing the brightness of the pixels by a percentage.

18. The apparatus of claim 15, wherein the at least one processor is further configured to:
determine a second ambient light intensity value using the under-display ambient light sensor located under the display screen; and
set a brightness of the image being displayed based on the second ambient light intensity value, using the second ambient light intensity value by image capture hardware and/or software, or a combination thereof.

19. The apparatus of claim 15, wherein the at least one processor is further configured to:
determine a third ambient light intensity value using the under-display ambient light sensor located under the display screen;
determine that the third ambient light intensity value is above a second ambient light intensity threshold; and
reverse or cancelling modifications made to the image being displayed within the first region of the display screen.

20. (canceled)

21. (canceled)

22. (canceled)

23. (canceled)

24. The apparatus of claim 15, wherein the first region of the display screen further comprises pixels within a predetermined distance from an outer boundary of the under-display ambient light sensor.

25. The apparatus of claim 15, wherein size, shape, or area of the first region of the display screen is dynamically adjusted by an operating system or application.

26. The apparatus of claim 15, wherein, to modify the image being displayed within a first region of the display screen, the at least one processor is configured to display additional information with the first region.

27. The apparatus of claim 15, wherein, to modify the image being displayed within a first region of the display screen, the at least one processor is configured to perform a transition effect from an unmodified state to a modified state or from the modified state to the unmodified state.

28. The apparatus of claim 15, wherein the at least one processor is further configured to adjust a user interface element in response to modifying the image being displayed within a first region of the display screen.

29. (canceled)

30. (canceled)
